(19) United States
(12) Patent Application Publication
(10) Pub. No.: US 2017/0194822 A1
(43) Pub. Date: Jul. 6, 2017

(54) NESTED STATOR STRUCTURE FOR DC MOTOR

(71) Applicant: XINGU MOTOR INC., Taipei City (TW)

(72) Inventor: Lien-Hsin WU, Taipei City (TW)

(21) Appl. No.: 15/066,370

(22) Filed: Mar. 10, 2016

(30) Foreign Application Priority Data
Dec. 31, 2015 (TW) 104144665

(51) Int. Cl. H02K 1/17; H02K 16/04; H02K 5/04; H02K 1/22

(52) U.S. Cl. CPC H02K 1/17; H02K 1/22; H02K 16/04; H02K 5/04

(57) ABSTRACT

The present invention provides a nested stator structure for a DC motor is applicable to a DC motor and includes an outer stator and an inner stator. The outer stator, mounted in the housing of the DC motor, includes outer magnets fixed to the inner wall of the housing along the circumferential direction of the housing. Each two adjacent outer magnets are spaced apart and have opposite polarities. The inner stator, mounted in the outer stator, has its front and rear ends fixed to the front and rear ends of the housing respectively, is provided with inner magnets along the circumferential direction of the housing, and is spaced from the outer stator by a rotation space, where a hollow rotor is received. When supplied with electricity, the hollow rotor generates electromagnetic fields repelling the inner and outer magnets and is hence rotated, driving an output element simultaneously to output a rotating force.

### BACKGROUND OF THE INVENTION

1. Technical Field

The present invention relates to a nested stator structure for a direct-current motor. More particularly, the present invention relates to a stator structure in which an outer stator is provided on the inner wall, and along the circumferential direction, of a cylindrical housing while an inner stator is provided along the axis of the housing such that a rotation space for receiving a hollow rotor is formed between the outer stator and the inner stator.

2. Description of Related Art

An electric motor, or generally referred to as a motor, serves mainly to convert the electricity received into mechanical energy and produce kinetic energy from the mechanical energy in order to drive another device. Motors, which are driven by electrical energy to output kinetic energy, have become indispensable devices in our daily lives not only because kinetic energy is a major form of energy for daily use, but also because electrical energy features ease of storage, ease of transmission, and cleanliness.

Generally speaking, motors can be divided by the driving electrical energy into direct-current (DC) motors, alternating-current motors, pulse motors, and so on. DC motors, whose “rotation speed vs. torque” and “current vs. torque” characteristic curves are linear, have readily controllable output speeds and relatively large starting torques and are therefore suitable for variable speed control and crucial to industrial automation. One objective of the present invention is to improve the conventional DC motors.

Referring to FIG. 1A, the structure of a conventional DC motor 1 essentially includes a housing 10, a pivot shaft 11, a rotor 12, a stator 13, and a commutator 14. The housing 10 is provided therein with a receiving space 101. The pivot shaft 11 is pivotally provided in the housing 10 and has one end formed as an output shaft 111. The output shaft 111 juts out of the housing 10. The rotor 12 is assembled from a plurality of silicon steel plates, is fixedly mounted around the pivot shaft 11, and is wound with a plurality of windings. The stator 13 is composed of permanent magnets, is fixedly provided on the inner wall of the housing 10, corresponds to the outer periphery of the rotor 12, and is spaced from the rotor 12. The commutator 14 is provided in the receiving space 101, is configured to receive external electricity, and is electrically connected to the windings in order to supply electricity to the windings. The commutator 14 can also change the direction of the current supplied to the windings.

According to Fleming's left-hand rule or right-hand palm rule, a conductive wire placed in a magnetic field and supplied with a current generates a magnetic field which cuts through the existing magnetic field lines such that the conductive wire is moved. When the windings on the rotor 12 are supplied with electricity, therefore, the magnetic fields generated by the windings cut through the lines of magnetic force generated by the stator 13, producing a torque that rotates the rotor 12 and thereby converts electrical energy into kinetic energy. For example, referring to FIG. 1B, where the lines of magnetic force of the stator 13 are from left to right, a current flowing into the windings of the rotor 12 from the right and exiting to the left causes the rotor 12 to generate a torque that forces the rotor 12 into clockwise rotation.

A DC motor, as indicated by the reference numeral 1 in FIG. 1A, is advantageous in that the rotation speed of its rotor 12 can be controlled with ease, and it is this advantageous feature that contributes to DC motors' applicability to industrial automation. To control the DC motor 1, the current in the windings can be varied in magnitude so that the stator 13 increases or decreases the kinetic energy of the windings. As the winding density has its limitations, and so does current variation, the inventor of the present invention wondered whether an improvement on the structure of the DC motor 1 may enhance the controllability and range of the speed of the rotor 12 without increasing the motor's overall volume significantly.

The inventor also found in his research that a conventional DC motor requires a transmission mechanism (e.g., a gear unit) to be mounted to the output shaft 111 in order to output the kinetic energy generated by the rotor 12. The arrangement of this transmission mechanism nevertheless leads to structural complexity and inevitable loss of kinetic energy. In addition, since the end of the output shaft 111 that juts oat of the housing 10 is a free end, the length of the output shaft 111 must be small enough to prevent the “axis shift” problem. However, when the pivot shaft 11 is rotated at high speed to generate the torque required to drive the transmission mechanism, the interface between the pivot shaft 11 and the transmission mechanism is subjected to a considerable load and therefore prone to wear and tear. Should the force acting on the pivot shaft 11 become uneven, the axis of the output shaft 111 may still shift as a result.

As stated above, the overall structure of the existing DC motors leaves something to be desired. DC motor manufacturers and designers are hence called for to improve the conventional DC motor structure so as to increase the controllability of a DC motor's rotation speed and solve the “axis shift” problem.

### BRIEF SUMMARY OF THE INVENTION

In view of the fact that the conventional DC motors leave room for betterment in the controllability of rotation speed and are susceptible to “axis shift” after long-term use, the inventor of the present invention conducted extensive research and experiment, and after repeated tests, analyses, and improvements, finally succeeded in developing a nested suitor structure for a DC motor as disclosed herein to enhance motor performance and durability.

It is an objective of the present invention to provide a nested stator structure for use in a DC motor. The nested stator structure is applicable to a DC motor which includes a housing. The housing is cylindrical and is provided therein with a receiving space. The nested stator structure includeS an outer stator and an inner stator. The outer stator is mounted in the receiving space and incudes a plurality of outer magnets. The outer magnets are fixed to the inner wall of the housing along the circumferential direction of the housing. Each two adjacent outer magnets are spaced apart and are opposite in polarity. The inner stator is mounted in the outer stator. The front and rear ends of the inner stator are fixed to the front and rear ends of the housing respectively. The inner stator and the outer stator are spaced by a rotation space configured for receiving a hollow rotor. The hollow rotor is spaced from the outer suitor by a first spacing and from the inner stator by a second spacing in order for the hollow rotor to rotate between the outer stator and the inner stator. The inner stator includes a plurality of inner magnets. The inner magnets are fixed to the outer periphery of the inner stator along the circumferential direction of the housing. Each two adjacent inner magnets are spaced apart and are opposite in polarity. The inner magnets correspond to the outer magnets respectively. When the windings on the hollow rotor receive the currents supplied by a commutator and generate the corresponding electromagnetic fields, the inner magnets on the inner stator and the outer magnets on the outerstator are repelled by the electromagnetic fields such that the hollow rotor is moved and drives an output element simultaneously. Thus, the rotating force generated by the hollow rotor is output to a load (e.g., a gearbox), wherein the rotating force features a low rotation speed and a large torque.

### BRIEF DESCRIPTION OF THE SEVERAL VIEWS OF THE DRAWINGS

The objects as well as the technical contents and features of the present invention will be best understood by referring to the following detailed description of a preferred embodiment in conjunction with the accompanying drawings, in which:

FIG. 1A schematically shows the structure of a conventional DC motor;

FIG. 1B schematically shows the working principle of a conventional DC motor;

FIG. 2 schematically shows a DC motor to which the stator structure of the present invention is applied;

FIG. 3 is a sectional view of the DC motor in FIG. 2;

FIG. 4 is a schematic plain view of the stator structure of the present invention;

FIG. 5 is a partial perspective view of the hollow rotor of the DC motor in FIG. 2; and

FIG. 6 schematically shows two windings on the hollow rotor of the DC motor in FIG. 2.

### DETAILED DESCRIPTION OF THE INVENTION

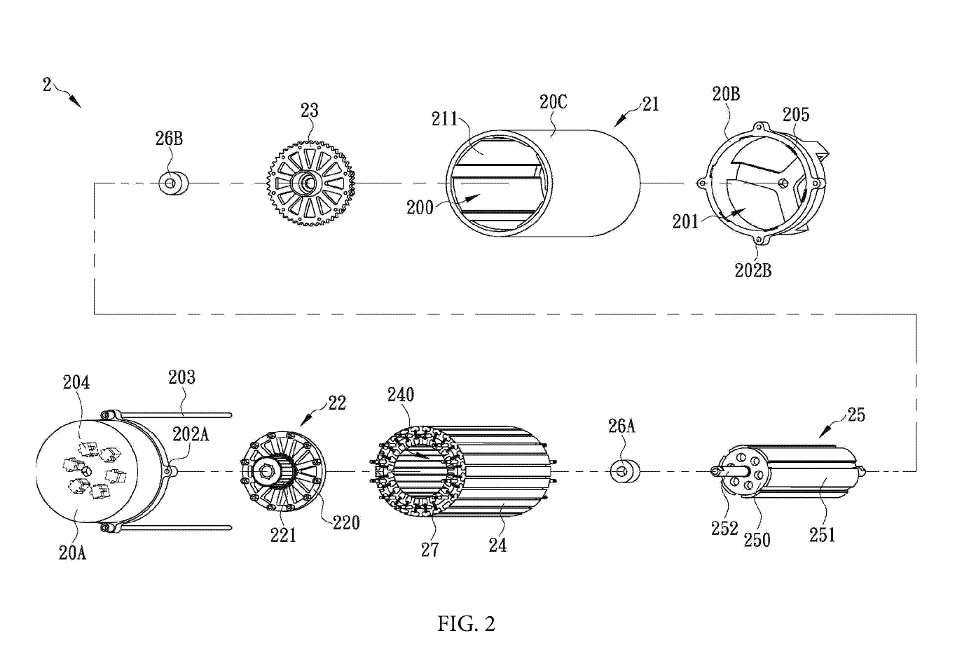

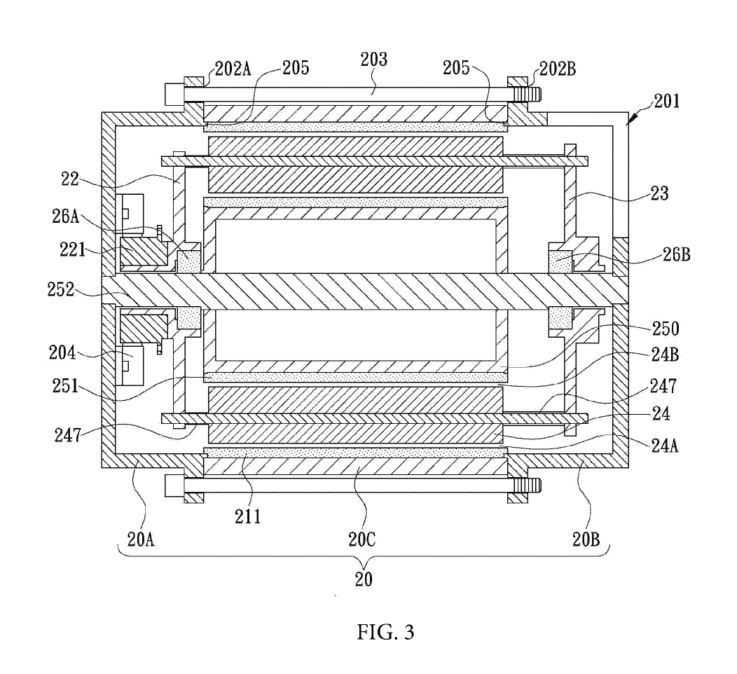

The present invention relates to a nested stator structure for a DC motor. Referring to FIG. 2 and FIG. 3 for the first preferred embodiment of the present invention, the nested stator structure is applied to a DC motor 2 and includes an outer stator 21 and an inner stator 25. In addition to the nested stator structure, the DC motor 2 includes a housing 20 (see FIG. 3), a commutator 22, an output element 23, and a hollow rotor 24. In this embodiment, the housing 20 is assembled from a front cover 20A, a rear cover 20B, and a housing body 20C and is, as a whole, a hollow cylinder with a receiving space 200 formed therein. The commutator 22 and the output element 23 are positioned in the front cover 20A and the rear cover 20B respectively.

In order to facilitate description of the relative positions of components, the rightward direction in FIG. 2 and FIG. 3 are defined as the “front” direction of each component, and the leftward direction, the “rear” direction of each component. The outer stator 21 is mounted in the receiving space 200 and includes a plurality of outer magnets 211. The outer magnets 211 are fixed to the inner wall of the housing 20 along the circumferential direction of the housing body 20C. Each two adjacent outer magnets 211 are spaced apart and are opposite in polarity. Each outer magnet 211 can be a single magnetic component or composed of a plurality of magnetic components of the same polar direction; the present invention has no limitations in this regard. In this embodiment, the outer magnets 211 are fixedly embedded in the inner wall of the housing body 20C; in other embodiments of the present invention, the outer stator 21 may include a tubular fixing base of a slightly smaller diameter than the housing body 20C, and the outer magnets 211 are fixedly provided on the inner wall of the tubular fixing base and are therefore indirectly positioned on the inner wall of the housing 20 via the tubular fixing base.

The inner stator 25 is mounted in the outer stator 21. The front and rear ends of the inner stator 25 are fixed to the front cover 20A and the rear cover 20B respectively. The inner stator 25 is spaced from the outer stator 21 by a rotation space large enough to receive the hollow rotor 24 and to keep a first spacing 24A between the hollow rotor 24 and the outer stator 21 and a second spacing 24B between the hollow rotor 24 and the inner stator 25, thereby allowing the hollow rotor 24 to rotate in the rotation space. The inner stator 25 includes an inner stator body 250 and a plurality of inner magnets 251. The inner magnets 251 are fixed to the outer periphery of the inner stator body 250 along the circumferential direction of the housing body 20C. Each two adjacent inner magnets 251 are spaced apart and are opposite in polarity. Each inner magnet 251 can be a single magnetic component or composed of a plurality of magnetic components of the same polar direction; the present invention has no limitations in this regard. The inner magnets 251 correspond in position to the outer magnets 211 respectively. In this embodiment, the area of each inner magnet 251 is smaller than that of the corresponding outer magnet 211 to ensure that the inner magnets 251 and the outer magnets 211 also correspond in number.

In this embodiment, each of the front and rear ends of the inner stator body 250 is protrudingly provided with a positioning rod 252. The positioning rods 252, which may alternatively be the two ends of a rod, as shown in FIG. 3, are connected to the front and rear ends of the housing 20 respectively in order for the axis of the inner stator 25 to correspond to the axis of the housing 20. In other embodiments of the present invention, the configuration of the inner stator body 250 may be modified according to design requirements.

The hollow rotor 24 is assembled from a plurality of iron cores and is formed with an axial hole 240 extending along the axial direction of the hollow rotor 24. The front end of the hollow rotor 24 is connected to the commutator 22 while the rear end of the hollow rotor 24 is connected to the output element 23. Moreover, the hollow rotor 24 is wound with a plurality of windings 27. When the windings 27 on the hollow rotor 24 are supplied with external currents (e.g., by the commutator 22, whose structure will be detailed further below) and generate the corresponding electromagnetic fields, the electromagnetic fields repel the inner magnets 251 on the inner stator 25 and the outer magnets 211 on the outer stator 21. As a result, the hollow rotor 24 is rotated and drives the output element 23 simultaneously (the commutator 22 is simultaneously driven as well), and the rotating force generated by the hollow rotor 24 is thus output to a load (e.g., a gearbox), vherein the rotating force features a low rotation speed and a large torque. Since the hollow rotor 24 is rotated under the joint action of the electromagnetic fields of the inner and outer stators 25 and 21, the rotation speed of the hollow rotor 24 can be controlled (e.g., varied) with greater ease than that of a conventional DC motor, which has only one stator, and the output element 23 can output a larger torque than its prior art counterpart.

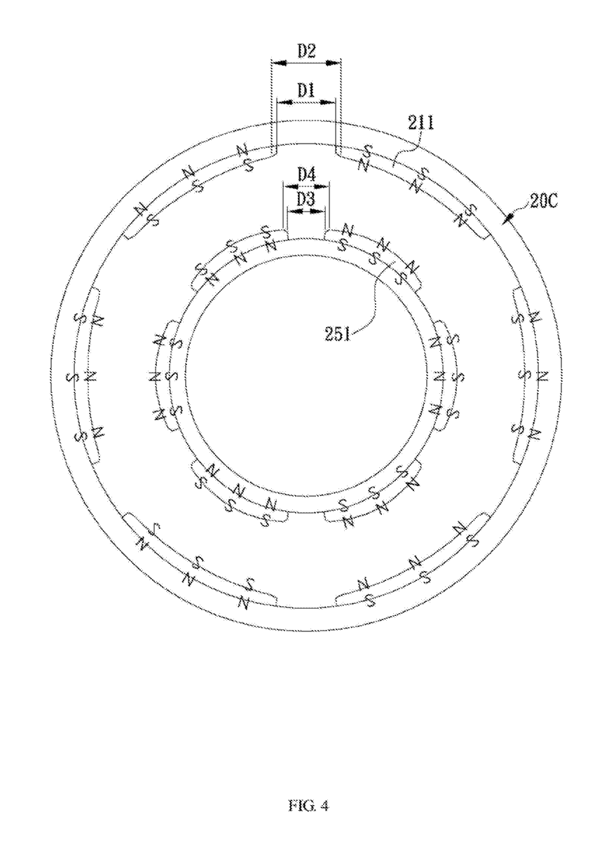

In order for the electromagnetic fields generated by the inner stator 25 and the outer stator 21 to drive the hollow rotor 24 more precisely, the inventor studied the arrangement of the inner magnets 251 and the outer magnets 211 at length and found that interference between the magnetic fields of the outer magnets 211 can be prevented by increasing the distance between the “magnetic pole ends” of each two adjacent outer magnets 211. Referring to FIG. 2 and FIG. 4, there are an inner spacing D1 and an outer spacing D2 between each two adjacent outer magnets 211, wherein the inner spacing D1 is a distance defined on the side adjacent to the inner wall of the housing 20 and the outer spacing D2 is a distance defined on the opposite side and is greater than the inner spacing D1 (each outer magnet 211 is provided with two chamfered edges to increase the outer spacing D2). Similarly, there are an inner spacing D3 and an outer spacing D4 between each two adjacent inner magnets 251, wherein the inner spacing D3 is a distance defined on the side distant from the hollow rotor 24 (or the outer stator 21) and the outer spacing D4 is a distance defined on the opposite side and is greater than the inner spacing D3.

According to the present invention, not only can the special structure consisting of the inner stator 25 and the outer stator 21 drive the hollow rotor 24 and the output element 23 stably and thereby generate a large-torque rotating force, but also the hollow rotor 24 is uniquely structured to improve output efficiency and reduce wear and tear. As shown in FIG. 2 and FIG. 3, the output element 23 corresponds in position to the at least one output hole 201 at the rear end of the housing 20 and is gear-shaped or formed as a hub or other component). Once a transmission element (e.g., a chain, closed-loop belt, or other component) is passed through the at least one output hole 201 and connected with the output element 23, the kinetic energy generated by the DC motor 2 during operation can be output to a load (e.g., a gearbox) sequentially through the output element 23 and the transmission element to drive the load into operation.

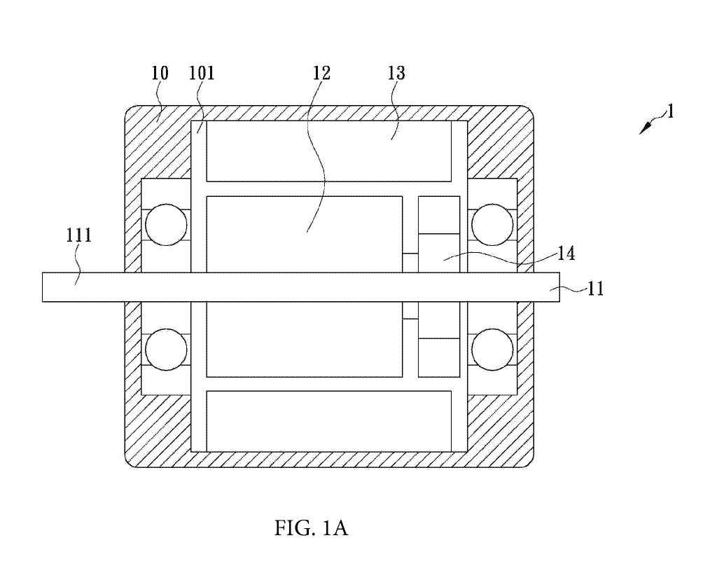

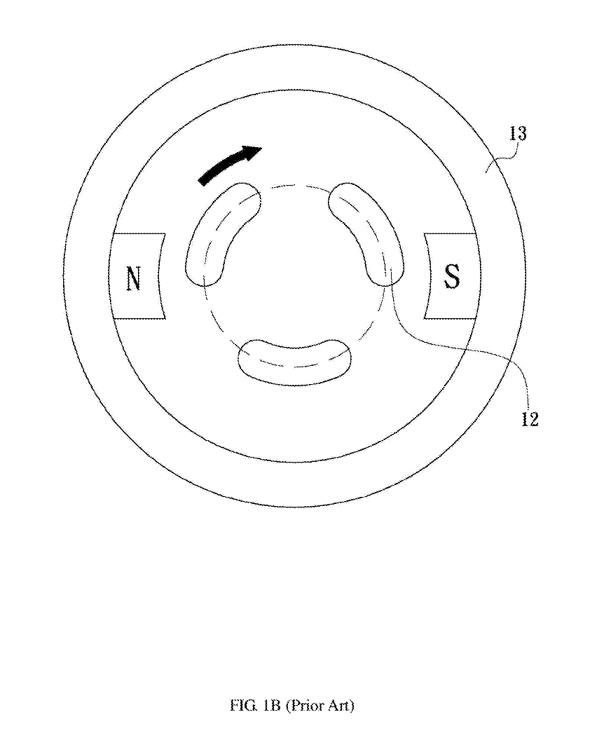

Due to the special configuration of the hollow rotor 24, referring to FIG. 2, the output element 23 is connected to an annular edge of the hollow rotor 24 (e.g., by a plurality of fixing rods 246, whose structure will he detailed further below), and this arrangement is different from that of the load-driving output shaft 111 (see FIG. 1A) of a conventional DC motor. Therefore, the axis shift problem typical of the conventional DC motors is prevented, and the DC motor 2 can generate a great rotating force at a low rotation speed to reduce wear and tear of its components and hence have a long service life.

To facilitate understanding of the technical principles of the present invention, the structure of the DC motor 2 is described in more detail below. To begin with, the housing 20 is so designed that the front cover 20A is peripherally provided with a plurality of front connecting portions 202A (e.g., locking holes) and is mounted therein with a plurality of carbon brushes 204 configured to receive an external current, that the rear cover 20B is formed with three output boles 201 and is peripherally provided with a plurality of rear connecting portions 202B (e.g., locking holes), and that the housing body 20C is tubular and is engaged between the front cover 20A and the rear cover 20B.

Each corresponding pair of front connecting portion 202A and rear connecting portion 202B are fixed to the two ends of a connecting rod 203 respectively such that the front cover 20A, the rear cover 20B, and the housing body 20C are connected together, forming the housing 20 of the present invention. To prevent the housing both 20C from rotation, the front cover 20A and the rear cover 20B are each provided with a plurality of engaging portions 205 (e.g., protruding plates) for engaging with one of the two ends of the housing body 20C.

The structure of the commutator 22 and its arrangement in relation to the carbon brushes 204 are briefly described as follows. The commutator 22 is located in the front cover 20A in order to be electrically connected to, and receive an external current through, the carbon brushes 204 in the front cover 20A. The commutator 22 includes a disk 220 and a plurality of commutator plates 221. The commutator plates 221 are mounted on the front side of the disk 220. Each two adjacent commutator plates 221 are spaced apart and are configured to reverse at a preset frequency the direction of the current they supply to the corresponding winding 27, thereby simultaneously reversing the electromagnetic field generated by the corresponding winding 27. The reversal is repeated again and again at the preset frequency.

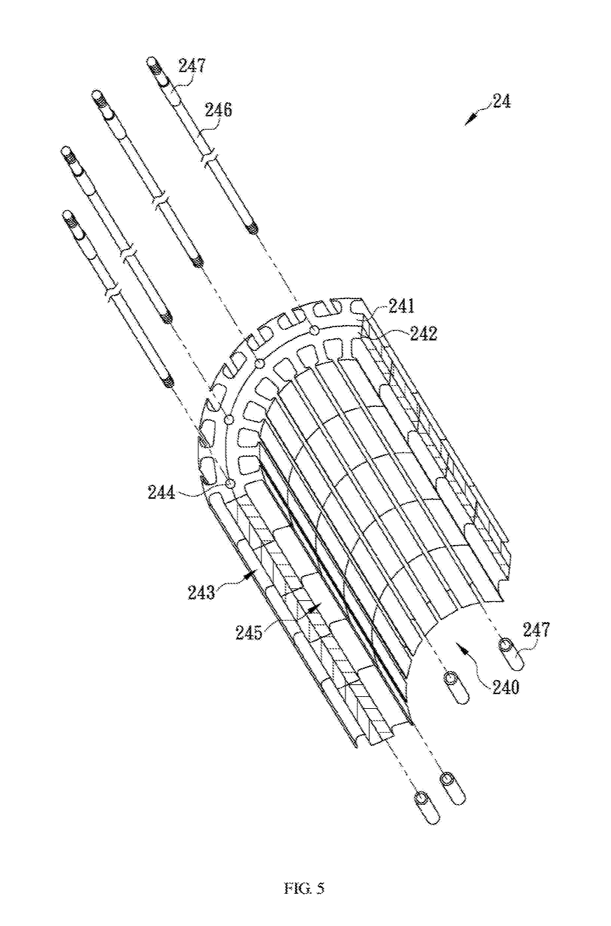

In this embodiment, referring to FIG. 2, FIG. 3, and FIG. 5, the hollow rotor 24 includes an outer iron core 241 and an inner iron core 242. The outer iron core 241 and the inner iron core 242 are each assembled from a plurality of silicon steel plates, are respectively and peripherally provided with a plurality of outer winding grooves 243 and a plurality of inner winding grooves 245, and jointly form a plurality of fixing holes 244. The outer winding grooves 243 extend in the axial direction of the outer iron core 241 while the inner winding grooves 245 extend in the axial direction of the inner iron core 242. The winding grooves 243 and 245 are configured to be wound with the windings 27, and the fixing holes 244, to receive a plurality of fixing rods 246 respectively inserted therethrough. The front end of each fixing rod 246 is fixed to the rear side of the disk 220 of the commutator 22, and the rear end of each fixing rod 246 is fixed to the output element 23, such that the hollow rotor 24, the commutator 22, and the output element 23 are assembled together as a single unit for simultaneous rotation. In addition, the commutator 22 and the output element 23 are respectively and centrally provided with bearings 26A and 26B. The positioning rods 252 of the inner stator 25 extend through the bearings 26A and 26B respectively before being fixed to the housing 20 and hence will not rotate with the commutator 22 or the output element 23.

To prevent the commutator 22 and the output element 23 from contact with the windings 27 on the hollow rotor 24, the front and rear ends of each fixing rod 246 are each mounted with a position-limiting tube 247 whose outer diameter is greater than the diameter of the fixing holes 244 and which therefore cannot extend into any fixing hole 211 and is located either between the commutator 22 and the hollow rotor 24 or between the output element 23 and the hollow rotor 24 to keep the commutator 22 or the output element 23 from contact with the windings 27 on the hollow rotor 24.

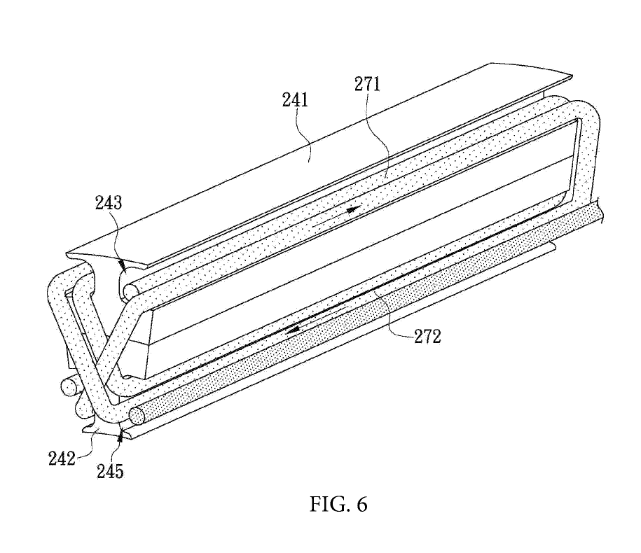

The experiments conducted by the inventor also show that the polar arrangement of the inner magnets 251 and the outer magnets 211 has certain effects on the rotation speed of the hollow rotor 24. Referring to FIG. 6 (which shows an example of how the windings 27 can be wound for the present invention) in conjunction with FIG. 2 and FIG. 4 (in which N and S represent magnetic poles), the winding 27 is so wound that the winding section 271 in the outer winding groove 243 and the winding section 272 in the inner winding groove 245 have opposite current directions.

With the foregoing winding scheme in place, if the corresponding outer magnet 211 and inner magnet 251 have the same polarity (e.g., both are N poles), Fleming's left-hand rule (in which the thumb indicates the direction of force, the index finger indicates the direction of the magnetic field, and the palm or bent middle finger indicates the direction of the current) dictates that the winding section 271, which is subjected to the magnetic field of the corresponding outer magnet 211 (the direction of this magnetic field is downward when the outer magnetic is an N pole), is forced toward the lower right corner of FIG. 6 such that the hollow rotor 24 is rotated clockwise. By the same token, the winding section 272, which is subjected to the magnetic field of the corresponding inner magnet 251 (the direction of this magnetic field is upward when the inner magnetic is an N pole), is also forced toward the lower right corner of FIG. 6. Thus, the polar arrangement ensures that the directions of the forces acting on the hollow rotor 24 are consistent. In practice, the winding scheme may vary as needed, and each corresponding pair of inner magnet 251 and outer magnet 211 may have opposite polarities to suit the current directions in different sections of the windings 27.

While the present invention has been described in connaction with certain exemplary embodiments, it is to be understood that the invention is not limited to the disclosed embodiments, but, on the contrary, is intended to cover various modificaions and equivalent arrangements included within the spirit and scope of the appended claims, and equivalents thereof.

What is claimed is:

1. A nested stator structure for a direct-current (DC) motor, applicable to a DC motor, wherein the DC motor comprises a housing, and the housing is provided therein with a receiving space, the nested stator structure comprising:
an outer stator mounted in the receiving space and comprising a plurality of outer magnets, wherein the outer magnets are fixed to an inner wall of the housing along a circumferential direction of the housing, and each two adjacent said outer magnets are spaced apart and are opposite in polarity; and
an inner stator mounted in the outer stator, the inner stator having a front end fixed to a front end of the housing and a rear end fixed to a rear end of the housing, the inner stator being spaced from the outer stator by a rotation space configured for receiving a hollow rotor, the hollow rotor being spaced from the outer stator by a first spacing and from the inner stator by a second spacing in order for the hollow rotor to rotate between the outer stator and the inner stator, the inner stator comprising a plurality of inner magnets, wherein the inner magnets are fixed to an outer periphery of the inner stator along the circumferential direction of the housing, each two adjacent said inner magnets are spaced apart and are opposite in polarity, and the inner magnets correspond to the outer magnets respectively.

2. The nested stator structure of claim 1, wherein each two adjacent said outer magnets are spaced by a first inner spacing on a side adjacent to the inner wall of the housing and are spaced by a first outer spacing on an opposite side, and the first outer spacing is greater than the first inner spacing.

3. The nested stator structure of claim 2, wherein each two adjacent said inner magnets are spaced by a second inner spacing on a side distant from the hollow rotor and are spaced by a second outer spacing on an opposite side, and the second outer spacing is greater than the second inn spacing.

4. The nested stator structure of claim 3, wherein the inner stator further comprises:
an inner stator body, the inner magnets being fixed to an outer periphery of the inner stator body; and
two positioning rods respectively and protrudingly provided at a front end and a rear end of the inner stator body, the positioning rods being connected to the front end and the rear end of the housing respectively.

5. The nested stator structure of claim 4, wherein each said outer magnet has a larger area than the corresponding inner magnet.

6. The nested stator structure of claim 1, wherein each said inner magnet and the corresponding outer magnet are identical in polarity.

7. The nested stator structure of claim 6, wherein each two adjacent said outer magnets are spaced by a first inner spacing on a side adjacent to the inner wall of the housing and are spaced by a first outer spacing on an opposite side, and the first outer spacing is greater than the first inner spacing.

8. The nested stator structure of claim 7, wherein each two adjacent said inner magnets are spaced by a second inner spacing on a side distant from the hollow rotor and are spaced by a second outer spacing on an opposite side, and the second outer spacing is greater than the second inner spacing.

9. The nested stator structure of claim 8, wherein the inner stator further comprises:
an inner stator body, the inner magnets being fixed to an outer periphery of the inner stator body; and
two positioning rods respectively and protrudingly provided at a front end and a rear end of the inner stator body, the positioning rods being connected to the front end and the rear end of the housing respectively.

10. The nested stator structure of claim 9, wherein each said outer magnet has a larger area than the corresponding inner magnet.

11. The nested stator structure of claim 1, wherein each said inner magnet and the corresponding outer magnet are opposite in polarity.

12. The nested stator structure of claim 11, wherein each two adjacent said outer magnets are spaced by a first inner spacing on a side adjacent to the inner wall of the housing and are spaced by a first outer spacing on an opposite side, and the first outer spacing is greater than the first inner spacing.

13. The nested stator structure of claim 12, wherein each two adjacent said inner magnets are spaced by a second inner spacing on a side distant from the hollow rotor and are spaced by a second outer spacing on an opposite side, and the second outer spacing is greater than the second inner spacing.

14. The nested stator structure of claim 13, wherein the inner stator further comprises:
an inner stator body, the inner magnets being fixed to an outer periphery of the inner stator body; and
two positioning rods respectively and protrudingly provided at a front end and a rear end of the inner stator body, the positioning rods being connected to the front end and the rear end of the housing respectively.

15. The nested stator structure of claim 14, wherein each said outer magnet as a larger area than the corresponding inner magnet.
